(19) United States
(12) Patent Application Publication
(10) Pub. No.: US 2010/0241533 A1
(43) Pub. Date: Sep. 23, 2010

(54) Tax data validity documentation

(76) Inventors: Li Ho, Washington, DC (US); Medei Kitagaki, San Jose, CA (US); Ben Chien, Sunnyvale, CA (US)

Correspondence Address: Valenti, Hanley & Robinson, PLLC, One Riverfront Plaza, 401 W. Main Street, Louisville, KY, 40202, US

(21) Appl. No.: 12/383,454

(22) Filed: Mar. 23, 2009

(51) Int. Cl. G06Q 10/00; G06F 3/048; G06F 17/30

(52) U.S. Cl. 705/30; 715/764; 707/E17.044; 707/E17.107

(57) ABSTRACT

A method and a system for data validity documentation are provided. The method may include receiving a number of data objects. The method may also include creating a number of event histories related to one or more data objects. One or more attachment documents may be associated with each one of multiple EH records of the event histories.

### CROSS REFERENCE TO RELATED APPLICATIONS

This is a non-provisional patent application claiming priority under 35 USC §119(e) to U.S. Provisional Patent Application No. 61/038,746, filed on Mar. 22, 2008, entitled, “TAX DATA VALIDITY DOCUMENTATION,” which is incorporated by reference in its entirety.

### TECHNICAL FIELD

Example embodiments relate generally to the technical field of data management, and, in one specific example, to a system and a method for data documentation.

### BACKGROUND

As companies continue to strive for efficiency, consistency and flexibility, computers and software executed on computers are increasingly relied upon to automate, semi-automate, enhance, quicken and make reliable and uniform business processes. As a result of rapidly expanding and increasingly cost-effective data storage and management capabilities and ever-increasing bandwidth in data communications, the appetite for increasingly robust software programs with greater access and use of business data has grown. Tax data may often be stored in computer databases where various operations may be readily performed upon the data, using the vast processing power of today's computer systems. A variety of tax software programs may assist individual or corporate accountants to prepare accurate tax documents. Some tax software programs are capable of importing required financial data related to accounts from databases of various financial institutions such as banks, mortgage companies, investment institutes, etc.

The convergence of SOX 404 and FASB Interpretation No. 48 (FIN 48) presents tax departments with an unprecedented level of process, documentation, and control requirements. To ensure compliance with FIN 48, tax departments are faced with the need to create a controlled and auditable environment that supports: processes and controls around managing tax positions across the entire organizational structure, all jurisdictions, and over multiple years; the development of a comprehensive inventory of tax positions (certain and uncertain) and balances; judgments regarding the technical merits of the positions; measurement of the appropriate impact to be reported in the financial statements; detailed documentation to be tracked for supporting the judgments around positions and their measured benefit; and new and substantive financial statement disclosures. In addition, with FIN 48, the assessment of the inventory of tax positions is a continual process. With each quarterly financial reporting cycle, decisions regarding the technical merits and proper measurements must be reevaluated, thus requiring the ability to capture and track ongoing analysis, approvals, and related documentation supporting decisions made throughout the process. What is needed is a system that addresses these process, control, and documentation requirements by providing a secure, controlled framework for identifying, evaluating, measuring, and reporting on tax positions—across entities, jurisdictions, and periods—in accordance with FIN 48 and other standards. Existing spreadsheet-based systems and document management tools fall short of facilitating multiple layers of decision making, reducing manual effort, supporting internal controls, and complementing existing tax provision processes. A need exists for a system to help companies comply with the process, documentation, and control requirements of FIN 48; streamline the preparation for, and process of, financial audits; reduce risk, increase accuracy, and improve tax department efficiency and effectiveness; adhere to company-defined SOX 404 controls and FIN 48 processes through a highly configurable, secure, and fully auditable framework.

### SUMMARY OF THE INVENTION

Tax data may often be stored in computer databases where various operations may a first embodiment, the invention provides a computer-implemented method comprising: creating by use of a graphical user interface an event history record; storing the event history record in a database, the event history record comprising a first data set associated with a first event, the first data set including tax related data; associating a tax related document with the event history record; and storing the tax related document. The method may further comprise one or more of: selecting by a user the event history record for viewing and editing; and retrieving the event history record from the database, modifying the first data set, and storing the modified first data set at the database. The tax related document may be one of the group consisting of legal opinion, tax opinion, technical analysis, and fact corroborating documentation, or it may include at least one of the group consisting of binary large objects (BLOBs), multimedia objects, image file, audio file, video file, html, pdf, text file, spreadsheet. The tax related document is associated with an assigned document identifier.

The event history record may include multiple versions of the first data set and a plurality of tax related documents respectively associated with one or more of the versions of the first data set. The event history record may include attributes associated with the first data set, including a time stamp attribute, and the method may further comprise: accessing the event history record; modifying the first data set, the modification resulting in a modified first data set, and associating a second time stamp attribute with the modified first data set. The method may further comprise associating a second tax related document with the modified first data set.

In another embodiment, the invention provides a computer-based system comprising: a database for storing and managing records; an event history generation module adapted to create an event history record, the event history record comprising a first data set associated with a first event, the first data set including tax related data; a graphical user interface (GUI) adapted to present event history related user screens and to facilitate data entry and storage associated with event history records; and an association module adapted to import a tax related document, associate the tax related document with the event history record, and store the tax related document. The system may further comprise one or more of: a selection module adapted to facilitate user selection of event history records for viewing; an event record retrieval module adapted to retrieve event history records from the database.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference. Some embodiments are illustrated by way of example and not limitation in the figures of the accompanying drawings in which:

FIG. 1 is a diagram illustrating, as an example embodiment, a network environment within which a system for data validity documentation may be implemented;

FIG. 2 is a block diagram illustrating, according to an embodiment, a system for data validity documentation;

FIG. 3 is a flow chart illustrating a method, according to an example embodiment, for data validity documentation;

FIG. 4 is a database schema illustrating, according to an example embodiment, various tables used by the databases of the system for data validity documentation; and

FIG. 5 is a diagrammatic representation of a machine in the example form of a computer system.

### DETAILED DESCRIPTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

An example method and system for data validity documentation is described. In the following description, for purposes of explanation, numerous specific details are set forth in order to provide a thorough understanding of example embodiments. However, it will be evident to one skilled in the art that the present invention may be practiced without these specific details.

In some example embodiments, an event history (EH) is a set of facts that is associated with one event, represented as an EH record in a data base table. For example, a tax auditor may make a series of tax data entries into a tax database over a period of time. This series of tax data entries may be represented as an EH. The auditor may then associate a tax opinion (e.g., a document) with the EH so as to corroborate, validate, or otherwise verify the data contained in the event history. This EH, and associated document, may be stored into a database wherein the document is an attachment associated with the EH.

In some example embodiments, a system and method is shown for corroborating factual data (e.g., tax data) by associating this factual data with a document. This document may be a legal opinion, tax opinion or some other document used to validate the factual data. This factual data may be aggregated into an event history (EH), and a document associated with this EH.

Some example embodiments illustrated herein may include receiving a number of data objects. The method may include creating a number of event histories related to one or more data objects. An event may be the updating of a fact data by, for example, editing a data element or an attached document or attaching a new document to a fact. A fact data may relate to tax calculations. One or more attachment documents may be associated with each one of multiple EH records of the event histories.

### Example System

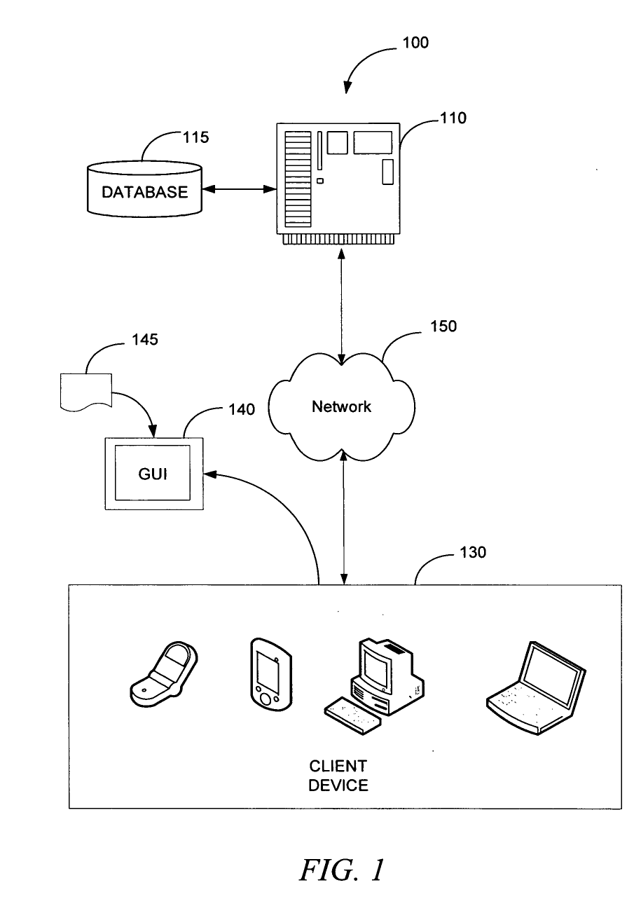

FIG. 1 is a high-level diagram illustrating an example embodiment of a system 100 for data validity documentation. The system 100 may include an application server 110 and a database 115 linked via a network 120. This network 120 may be the Internet, Local Area Network (LAN), Wide Area Network (WAN), or some other network of a suitable topology. Additionally, connected to the network 120 may be a client device 130 (e.g., a desktop computer, a laptop computer, a personal digital assistant (PDA), a cell phone, a smart phone, or other suitable networkable device). The connection between the client device 130 and the application server 110 may be a physical or logic connection utilizing one or more protocols outlined in the Transmission Control Protocol (TCP)/Internet Protocol (TCP/IP) stack model, or Open Systems Interconnection (OSI) model. The application server 110 may provide users of the client device 130 with a graphical user interface (GUI) 140 as rendered by the client device 130. This GUI 140 may be a browser application (e.g., INTERNET EXPLORER™, or FIREFOX™) that interprets and renders web pages served up, directly or indirectly, by the application server 110. The GUI 140 may be used by online users to interact, via the network 120, with the application server 110. In some example embodiments, users may directly interact with the application server 110 via the system and method shown herein as a stand-alone application not requiring the use of the network 120.

In example embodiments, the application server 110 may receive a number of data objects representing, for example, facts. These facts may be received via the GUI 140. The application server 110 may store the facts in the database 115. The facts may be related to a corporate tax account, an investment portfolio, an administrative documentation, or may be used for some other suitable purpose. EHs, for example, may be created by updating and validating facts through editing one or more attributes included in the facts. Each EH may consist of a number of records contained in the database representing these facts.

In some example embodiments, the database 115 may store various versions of facts. A fact, as referenced elsewhere, may be tax data. A version of a fact may be versions of tax data, where this data is stored (e.g., warehoused) into the database 115 and this tax data is modified and updated over time. In some example cases, an EH may be associated with each version of the tax data. Further, a document in the form of, for example, a corroborating tax opinion may be associated with each EH.

The concept of versioning of facts and the associating of documents with each EH generated from a particular version of fact may be illustrated with the following example. At time 1/1/08 a version 1 of tax data is created. At time 1/2/08 a version 2 of the same tax data is created, where version 2 contains certain modifications of this tax data. Version 1 and version 2 may be assembled into an EH, and a written opinion (e.g., a document) generated regarding the validity of the data making up this version 1 and version 2. This written opinion may then be associated with this EH.

In one example embodiment, the user may select a document 145 from a GUI 140 (e.g., an interface tier) and associate the document 145 with an EH record. In another example embodiment, the user may import or generate the document, and then associate the document with the EH record. As illustrated elsewhere, this document 145 may be an opinion (e.g., a legal opinion, or a tax opinion, etc.) regarding the facts outlined in the EH record.

### Example Logic Tier

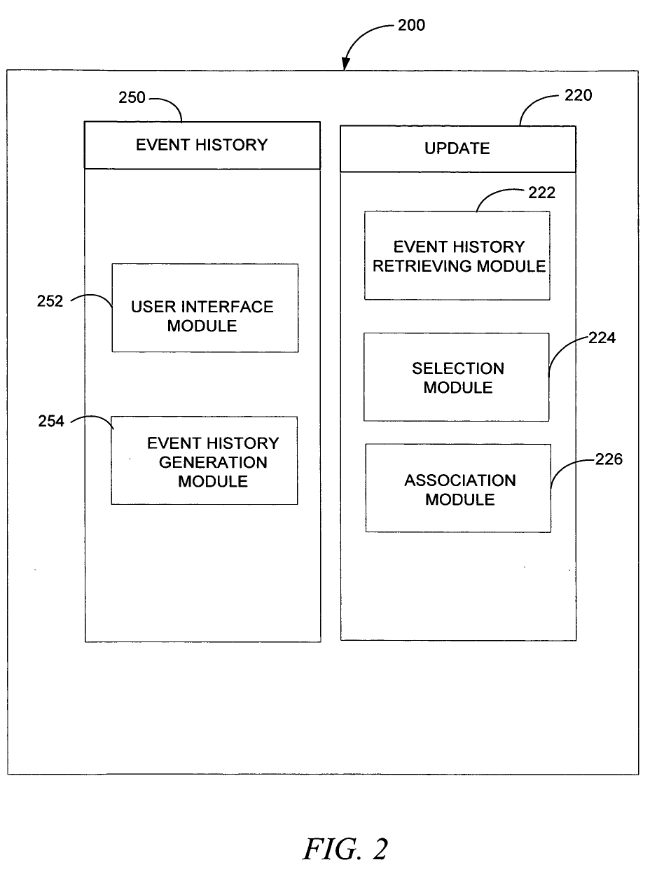

FIG. 2 is a block diagram illustrating an example embodiment of a system 200 for data validity documentation. The various blocks outlined in FIG. 2 may be implemented in software, hardware, or firmware. Additionally, these blocks may be implemented as part of the aforementioned application server 110, the client 130, or some other suitable device. The system 200 may include an EH sub-system 250 and an update sub-system 220. The EH sub-system 250 may include a user interface module 252 and an EH generation module 254. The update sub-system 220 may include an EH retrieving module 222, a selection module 224, and an attachment module 226.

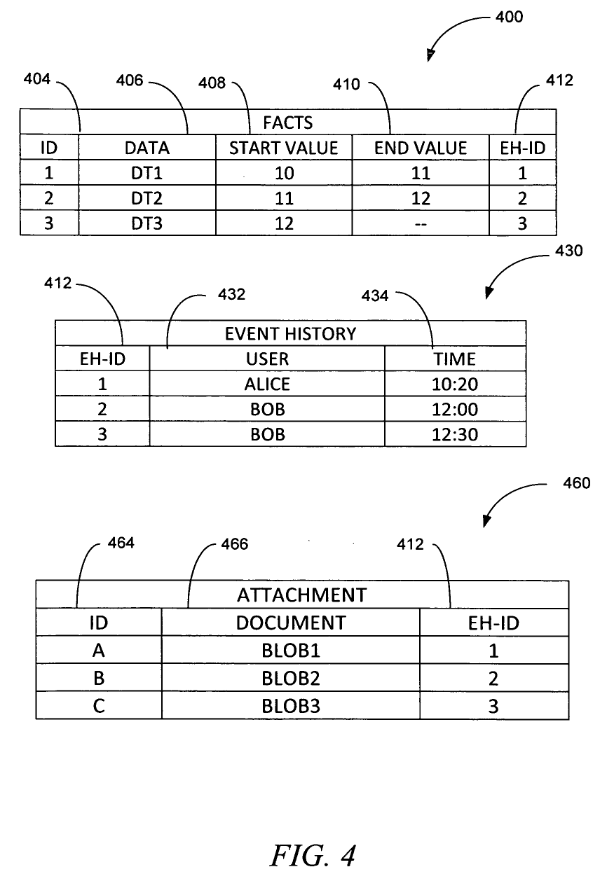

In example embodiments, the user interface module 252 may receive a number of facts (e.g., tax related data) from users of the application server 110. The users may provide the fact directly to the application server 110, or via a web-based link using the GUI 140. The GUI 140 may also be generated and supported by the user interface module 252. The fact may be imported to the application server from the database 115. Each fact may include a number of attributes such as attributes shown in facts table 400 of FIG. 4 (e.g., fact identification (ID) 404, data 406, start value 408, end value 410, and EH ID 412).

The EH generation module 254 may facilitate creation of event histories (e.g., FIG. 4, EH table 430) by users of the system 200. The EH generation module 254 may provide certain GUIs for the users to review, edit and validate various facts, thereby generating event histories. For example, the user may be a tax accountant connecting to the application server 110 via the Internet, to review one or more facts related to a corporate tax account. The EH generation module 254 may support the tax accountant activities, while generating an EH by updating one or more attributes (e.g., data 406, start value 408, end value 410, etc., as shown in facts table 400 of FIG. 4) included in the facts of interest. The generated EH may be saved in the database 115.

According to an example embodiment, the users may update one or more EH records related to one or more facts. The updating may be performed by associating a number of documents (e.g., an attachment) to one or more of the retrieved EH records. The EH retrieving module 222 may retrieve the EH records from the database 115. The selection module 224 may support selection of the one or more EH records by the users. The selection module 224 may, for example, provide GUIs that may facilitate the selection process. The GUIs may include various query boxes, where the users may enter keywords, EH identification numbers (EH-ID) or other information identifying or relating to the one or more desired history records. The GUIs may also present to the users selection boxes, from which one or more EH records may be selected from a list of existing EH records related to one or more facts.

In an example embodiment, the association module 226 may be tasked to facilitate associating of documents to one or more EH records. The association module 226 may allow the users to import documents into the application server 110, from various sources, using the client device 130. In another example embodiment, the association module 226 may provide GUIs, including selection boxes, from which one or more documents may be selected.

In example embodiments, the documents may include legal opinions, tax opinions, technical analyses, or other corroborating documents that may support the facts, to which the EH record may be related. The documents may also include binary large objects (BLOB) such as multimedia objects (e.g., images, audio, or video files), or large portable document format (PDF) files. Each document may have an assigned document identification number (FIG. 4, attachment table 460).

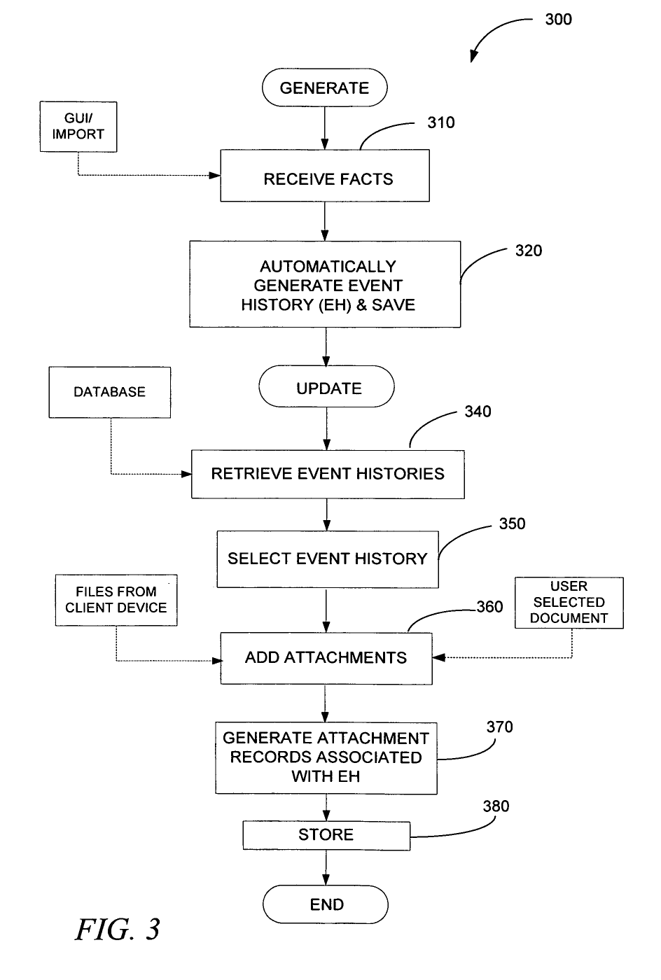

FIG. 3 is a high-level flow diagram illustrating an example method 300 for data validity documentation. The method 300 may include a generation part and an update part. An operation 310 is shown, where the user interface module 252 may receive a number of facts. These facts may be received from a user. The facts may be imported to application server 110 via one or more GUIs, in a client server or stand alone implementation. At operation 320, the EH generation module 254 may generate one or more event histories related to the facts. The event histories may be stored in the database 115.

According to an example embodiment, the update part of the method 300 may start at operation 340, where the EH retrieving module 222 may retrieve a number of EH records from the database 115. The user may select one or more of the EH records for updating (see operation 350). The selection process may be facilitated by GUIs provided by the selection module 224, where selection boxes may allow the user to make a selection from a displayed list of EH records. At operation 360, the user may import one or more documents to the application server 110, using the GUIs provided by the association module 226. The documents may also be selected from a list of existing documents in the database 115 displayed by one or more of the GUIs.

In an example embodiment, at operation 370, the one or more documents selected by the user may be associated with one or more EH records related to one or more related facts, thereby updating EH records. At operation 380, the updated EH records may be saved in the database 115. Each EH record may include a number of EH attributes (e.g., EH-ID 412, user 432, time 434, as shown in the EH table 430 of FIG. 4.)

### Example Database Tier

Some embodiments may include the various databases (e.g., database 115) being relational databases, or in some cases an On Line Analytic Processing (OLAP) based databases. In the case of relational databases, various tables of data are created and data is inserted into, and/or selected from, these tables using SQL, or some other database-query language known in the art. In the case of OLAP databases, one or more multi-dimensional cubes or hyper-cubes containing multidimensional data, from which data is selected from or inserted into using MDX may be implemented. In the case of a database using tables and SQL, a database application such as, for example, MySQL™, SQLServer™, Oracle 8I™, 10G™, or some other suitable database application may be used to manage the data. In this, the case of a database using cubes and MDX, a database using Multidimensional on Line Analytic Processing (MOLAP), Relational On Line Analytic Processing (ROLAP), Hybrid Online Analytic Processing (HOLAP), or some other suitable database application may be used to manage the data. These tables or cubes made up of tables, in the case of, for example, ROLAP, are organized into a RDS or Object Relational Data Schema (ORDS), as is known in the art. These schemas may be normalized using certain normalization algorithms, so as to avoid abnormalities such as non-additive joins and other problems. Additionally, these normalization algorithms may include Boyce-Codd Normal Form or some other normalization, optimization algorithm known in the art.

FIG. 4 is database schema illustrating an example embodiment of tables used by the databases of a system for data validity documentation. The database 115 of FIG. 1 may include a number of tables such as facts table 400, EH table 430, and an attachment table 460. The facts table 400 may include fields representing fact attributes including fact ID 404, Data 406, start value 408, end value 410, and EH-ID 412. The data 406 (such as DTI) may include information related to a fact ID (such as 1). The information may, for example, include appraised property tax amount, in a particular tax jurisdiction, for a certain fiscal year, associated with a corporation. The start and end values 408 and 410 may embrace various meanings, based on the nature of the fact. For example, where the fact is a time dependent event, the start and end values 408 and 410 may mean a start and an end time for that event, respectively.

In an example embodiment, each fact of the facts table 400 may be cross-linked to the EH table 430 via the EH-ID 412 attribute. The EH-ID 412 may also cross link the attachment table 460 to the EH table 430. Fields of the EH 430 may include EH-ID 412, user 432, and time 434. Attachment table 460 shows attachment table fields including attachment ID 464, document 466, and EH-ID 412. The document 466 (e.g., blob 1) may represent a name of a document identified by an attachment ID (e.g., A). Each record of the attachment table 460 may be related to a record of the EH table having the same EH-ID value.

In some example embodiments, the fact may be represented by an account-data-fact shown in Table 1 below, where, various attributes of the account-data-fact are shown in column 1. Also shown are the data-types for each attribute and a primary key. The primary key may be used in linking this Table 1 with other tables such as an EH table (e.g., Table 2).

TABLE 1
Main Fact Table
ACCOUNTDATA_FACT

| | | | Pri- |
|---|---|---|---|
| | | | mary |
| Column | Datatype | Nullable | Key |
| JURISDICTION_ID | VARCHAR2(255) | No | 1 |
| ENTITY_ID | VARCHAR2(255) | No | 2 |
| PARENT_NAME | VARCHAR2(255) | No | 3 |
| FACTOR | NUMBER(10,0) | No | 4 |
| ACCOUNT_NAME | VARCHAR2(255) | No | 5 |
| ACCOUNTDATATYPE | NUMBER(10,0) | No | 6 |
| TRANSACTIONTIMEEND | TIMESTAMP(6) | No | 7 |
| YEAR | NUMBER(10,0) | No | 8 |
| TRANSACTIONTIMESTART | TIMESTAMP(6) | Yes | |
| BEGINVALUE | FLOAT | No | |
| ENDVALUE | FLOAT | No | |
| EVENTID | NUMBER(10,0) | Yes | |

An example EH and attachment table is shown in Table 2. An EH may include attributes such as EH ID and user-ID, identifying the EH and the user updating the fact data. An event-time-stamp attribute may indicate a time at which the updating event occurred. An event-operation-type may show the type of the event (e.g., editing certain data fields, attaching documents, validating data, etc.) Other attributes shown in the EH table are self-explanatory. The attachment table shows attributes of an attachment including an event ID attribute, that relates the attachment table with the EH table.

TABLE 2
EH and Attachment Table

| | | | |
|---|---|---|---|
| | | | Primary |
| Column | Datatype | Nullable | Key |

EVENT_HISTORY

| | | | |
|---|---|---|---|
| ID | NUMBER(10,0) | No | 1 |
| KEYSTRING | VARCHAR2(255) | Yes | |
| EVENTTIMESTAMP | TIMESTAMP(6) | Yes | |
| USERID | VARCHAR2(255) | Yes | |
| EVENTOPERATIONTYPE | NUMBER(10,0) | Yes | |
| EVENTOBJECTTYPE | NUMBER(10,0) | Yes | |
| USERCOMMENT | VARCHAR2(512) | Yes | |
| YEAR | NUMBER(10,0) | Yes | |

ATTACHMENT

| | | |
|---|---|---|
| FILENAME | VARCHAR2(255) | Yes |
| TIMESTAMP | TIMESTAMP(6) | Yes |
| USERID | VARCHAR2(255) | Yes |
| FILECONTENT | BLOB | Yes |
| EVENTID | NUMBER(10,0) | Yes |

### Example Computer System

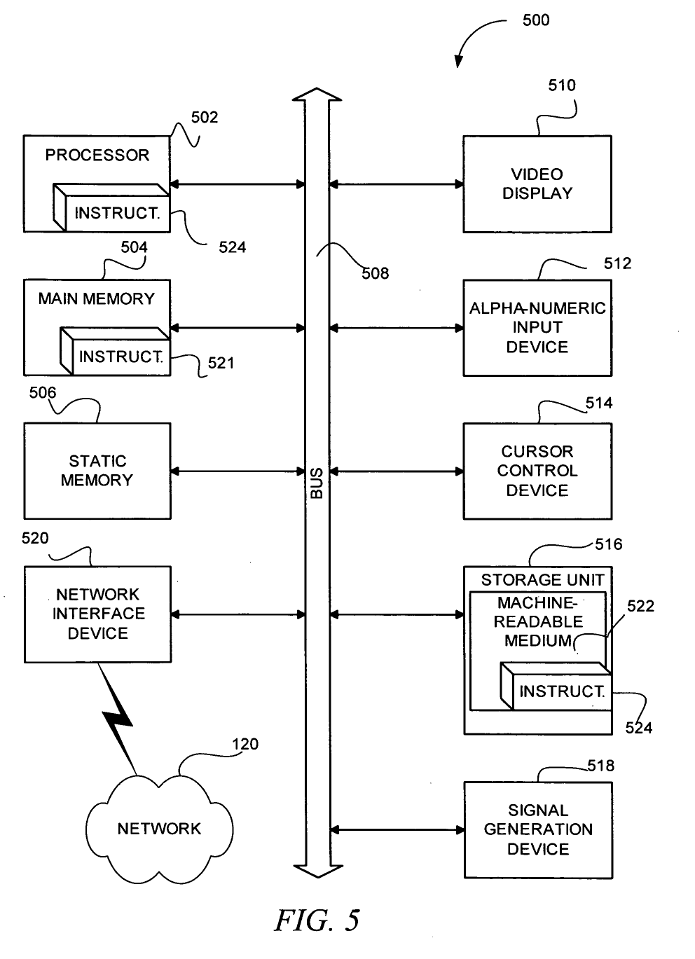

FIG. 5 illustrates a diagrammatic representation of a machine in the example form of a computer system 500 within which a set of instructions may be executed to cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a storage unit 516 (e.g., hard-disk drive), a signal generation device 518 (e.g., a speaker) and a network interface device 520.

The storage unit 516 includes a machine-readable medium 522 on which is stored one or more sets of instructions (e.g., software 524) embodying any one or more of the methodologies or functions illustrated herein. The software 524 may also reside, completely or at least partially, within the main memory 504 and/or within the processor 502 during execution thereof by the computer system 500, the main memory 504 and the processor 502 also constituting machine-readable media. The software 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

A method and a system for data validity documentation have been illustrated. Although the present invention has been illustrated with reference to specific example embodiments, it will be evident that various modifications and changes may be made to these embodiments without departing from the broader spirit and scope of the invention. Accordingly, the specification and drawings are to be regarded in an illustrative rather than a restrictive sense.

### A Three-Tier Architecture

In some embodiments, a method is illustrated as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier, and/or to a backend, or storage tier. These logical/mathematical manipulations may relate to certain business rules, or processes that govern the software application as a whole. A third, storage tier, may be a persistent storage medium or non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or so some other suitable configuration. Further, these three tiers may be distributed between more than one computer system as various software components.

### Component Design

Some example embodiments may include the above illustrated tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a visual component library (VCL), component library for cross platform (CLX), java beans (JB), java enterprise beans (EJB), component object model (COM), distributed component object model (DCOM), or other suitable technique. These components may be linked to other components via various application programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the OSI model, or TCP/IP protocol stack model for defining the protocols used by a network to transmit data.

### A System of Transmission Between a Server and Client

Some embodiments may utilize the OSI model or TCP/IP protocol stack model for defining the protocols used by a network to transmit data. In applying these models, a system of data transmission between a server and client, or between peer computer systems is illustrated as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an Internet, LAN, WAN, or some other suitable network. In some cases, the Internet refers to a network of networks. These networks may use a variety of protocols for the exchange of data, including the aforementioned TCP/IP, or some other suitable protocol. These networks may be organized within a variety of topologies (e.g., a star topology), or structures.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A computer-implemented method comprising:
creating by use of a graphical user interface an event history record;
storing the event history record in a database, the event history record comprising a first data set associated with a first event, the first data set including tax related data;
associating a tax related document with the event history record; and
storing the tax related document.

2. The method of claim 1 further comprising selecting by a user the event history record for viewing and editing.

3. The method of claim 1 further comprising retrieving the event history record from the database, modifying the first data set, and storing the modified first data set at the database.

4. The method of claim 1, wherein the tax related document is one of the group consisting of legal opinion, tax opinion, technical analysis, and fact corroborating documentation.

5. The method of claim 1, wherein the tax related document includes at least one of the group consisting of binary large objects (BLOBs), multimedia objects, image file, audio file, video file, html, pdf, text file, spreadsheet.

6. The method of claim 1, wherein the tax related document is associated with an assigned document identifier.

7. The method of claim 1, wherein the event history record includes multiple versions of the first data set and a plurality of tax related documents respectively associated with one or more of the versions of the first data set.

8. The method of claim 1, wherein the event history record includes attributes associated with the first data set, including a time stamp attribute, and further comprising:
accessing the event history record;
modifying the first data set, the modification resulting in a modified first data set, and
associating a second time stamp attribute with the modified first data set.

9. The method of claim 8 further comprising associating a second tax related document with the modified first data set.

10. A computer-based system comprising:
a database for storing and managing records;
an event history generation module adapted to create an event history record, the event history record comprising a first data set associated with a first event, the first data set including tax related data;
a graphical user interface (GUI) adapted to present event history related user screens and to facilitate data entry and storage associated with event history records; and
an association module adapted to import a tax related document, associate the tax related document with the event history record, and store the tax related document.

11. The system of claim 10 further comprising a selection module adapted to facilitate user selection of event history records for viewing.

12. The system of claim 10 further comprising an event record retrieval module adapted to retrieve event history records from the database.

13. The system of claim 10, wherein the tax related document is one of the group consisting of legal opinion, tax opinion, technical analysis, and fact corroborating documentation.

14. The system of claim 10, wherein the tax related document includes at least one of the group consisting of binary large objects (BLOBs), multimedia objects, image file, audio file, video file, html, pdf, text file, spreadsheet.

15. The system of claim 10, wherein the tax related document is associated with an assigned document identifier.

16. The system of claim 10, wherein the event history record includes multiple versions of the first data set and a plurality of tax related documents respectively associated with one or more of the versions of the first data set.

17. The system of claim 10 further adapted to permit access to the event history record for modification of the first data set, the modification resulting in a modified first data set.

18. The system of claim 10 further adapted to permit association of a second tax related document with the modified first data set.

19. The system of claim 10, wherein the event history record includes attributes associated with the first data set, including a time stamp attribute, and further comprising code adapted to permit accessing the event history record and modifying the first data set, the modification resulting in a modified first data set, and wherein the association module is further adapted to associate a second time stamp attribute with the modified first data set.
